(19) United States
(12) Patent Application Publication
(10) Pub. No.: US 2007/0286962 A1
(43) Pub. Date: Dec. 13, 2007

(54) Methods for producing non-glossy coatings from radiation curable compositions

(76) Inventors: Randall R. Brown, High Point, NC (US); Randolph G. Cox, High Point, NC (US)

Correspondence Address: PPG INDUSTRIES INC;INTELLECTUAL PROPERTY DEPT, ONE PPG PLACE, PITTSBURGH, PA, 15272, US

(21) Appl. No.: 11/450,481

(22) Filed: Jun. 9, 2006

(51) Int. Cl. C08F 2/46

(52) U.S. Cl. 427/487

(57) ABSTRACT

The present invention relates to methods for producing non-glossy coatings on a substrate, wherein the coating results from deposition of a radiation curable composition to at least a portion of the substrate, followed by subjecting the coated substrate to ionizing radiation or actinic light in an inert atmosphere. The methods of the present invention do not include the step of subjecting the coated substrate to ionizing radiation or actinic light in an atmosphere containing a low gloss imparting amount of oxygen.

### FIELD OF THE INVENTION

The present invention relates to methods for producing non-glossy coatings on a substrate, wherein the coating results from the deposition of a radiation curable composition to at least a portion of the substrate, followed by subjecting the coated substrate to ionizing radiation or actinic light in an inert atmosphere. The methods of the present invention do not include the step of subjecting the coated substrate to ionizing radiation or actinic light in an atmosphere containing a low gloss imparting amount of oxygen.

### BACKGROUND OF THE INVENTION

Coatings formed from many radiation curable coating compositions, when exposed to ultraviolet light or an electron beam, are cured to glossy, crosslinked films. In many instances, however, it is desired to obtain non-glossy crosslinked coatings from such compositions. One way to achieve reduced gloss coatings is by adding flatting pigment. The presence of significant amounts of flatting pigment, however, can have a detrimental impact on the properties of a coating.

As a result, various methods have been employed to produce non-glossy coatings from radiation curable compositions that contain an appropriate amount of flatting pigment. These methods involve conducting at least a portion of the curing process in the presence of oxygen. In one method, a two step curing process is employed wherein polymerization of certain coating compositions is inhibited in surface portions in the first step by the presence of oxygen (air), and curing of the coating is completed in a second step in an inert atmosphere. In another method, the entire curing process is conducted in the presence of air, and entails the use of multiple curing stages of varying intensities. In each of these methods, it is believed that shrinkage of underlying portions of the composition in the initial curing stages allows flatting pigment particles to be driven into the surface portions, whereby the surface contains a larger amount of flatting pigment than the body of the film. This is believed to reduce the gloss of the film without sacrificing coating properties.

While often effective, there can be certain drawbacks to the use of such “air cure” techniques. In particular, there are certain applications in which it is impossible or undesirable to conduct any cure steps in an air atmosphere due, for example, to the presence of certain coating components that are not compatible with the use of such an “air cure”.

As a result, it would be advantageous to provide a method for producing non-glossy coatings on a substrate from radiation curable compositions, wherein the coating is cured in an inert atmosphere and wherein the coating exhibits properties, such as stain resistance and/or scratch-resistance, comparable to coatings of similar gloss that are produced using an air cure coating technique.

### SUMMARY OF THE INVENTION

In certain respects, the present invention is directed to methods for producing a coating on a substrate. These methods comprise: (a) depositing a radiation-curable coating composition to at least a portion of the substrate to form an at least partially coated substrate, and (b) subjecting the at least partially coated substrate to ionizing radiation or actinic radiation in an inert atmosphere to cure the radiation-curable composition. The methods of the present invention produce a coating that is non-glossy. These methods, however, do not include the step of at least partially curing the radiation-curable composition by subjecting the at least partially coated substrate to ionizing radiation or actinic radiation in an atmosphere containing a low gloss imparting amount of oxygen.

The present invention is also directed to substrates at least partially coated with a non-glossy coating produced by such methods, as well as coating compositions suitable for use in such methods.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of“1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As previously indicated, certain embodiments of the present invention are directed to methods for producing a coating on a substrate. Any of a wide variety of substrates may be coated according to the methods of the present invention. Suitable organic substrates include, for example, wood and wood veneer, including wood flooring, desks, table tops, and the like, fiberboard, particle board, composition board, paper, cardboard, and various polymers, such as vinyl flooring, polyesters, polycarbonates, polyamides, phenolic resins, aminoplasts, acrylic, polyurethanes, and rubber, among others. Suitable inorganic substrates include, for example, glass, quartz, ceramics, and metals, such as iron, steel, stainless steel, copper, brass, bronze, aluminum, magnesium, titanium, nickel, chromium, zinc, and alloys thereof.

In the methods of the present invention, a radiation-curable coating composition is deposited to at least a portion of the substrate to form an at least partially coated substrate. Any suitable coating deposition technique may be used, such as, for example, spraying, curtain coating, dipping, roll coating, printing, brushing, and the like. In certain embodiments, the radiation-curable composition is deposited so as to result in a dry film thickness of up to 75 microns (3 mils), in some cases up to 100 microns (4 mils).

In the methods of the present invention, a radiation-curable composition is deposited to at least a portion of the substrate. As used herein, the term “radiation-curable composition” refers to a composition that comprises a radiation curable polymer or monomer. As used herein, the term “radiation curable polymer or monomer” refers to monomers or polymers having reactive components that are polymerizable by exposure to ionizing radiation or actinic radiation, as described in more detail below.

In certain embodiments, the radiation-curable composition utilized in the practice of the methods of the present invention comprises a radiation-curable polymer. As used herein, the term “polymer” is meant to refer to prepolymers, oligomers and both homopolymers and copolymers; the -prefix “poly” refers to two or more. Suitable radiation-curable polymers include, for example, ethylenically unsaturated polyesters, ethylenically unsaturated acrylics, ethylenically unsaturated polyethers, ethylenically unsaturated polyurethanes, ethylenically unsaturated epoxies, ethylenically unsaturated silicon-based polymers, i.e., polymers comprising one or more —SiO— units in the backbone, polymers comprising vinyl ether, and fluorochemical acrylate polymers, such as those described in U.S. Pat. Nos. 6,649,719; 3,341,497 and 3,462,296, among others.

In certain embodiments, the radiation-curable composition utilized in the practice of the methods of the present invention comprises a urethane acrylate, i.e., a urethane modified to have (meth)acrylate functionality. As used herein, the term “(meth)acrylate” is meant to encompass acrylates and methacrylates. In certain embodiments, the urethane acrylate utilized in the practice of the methods of the present invention contains a plurality of polymer groups, such as polyether or polyester groups, linked through urethane linking groups. In many cases, (meth)acrylate groups are present at each terminal end of the polymer.

In certain embodiments, the radiation-curable polymer is present in such radiation curable compositions in an amount of 1 to 60 percent by weight, such as 30 to 50 percent by weight, with the weight percents being based on the total weight of the composition.

In certain embodiments, the radiation curable composition utilized in the practice of the methods of the present invention comprises a radiation-curable monomer. As used herein, the term “monomer” refers to a single unit molecule that can combine with other molecules to form a polymer. Suitable radiation curable monomers include, for example, vinyl compounds, (meth)acrylates, heterocyclic vinyl compounds, and/or vinyl ethers.

In certain embodiments, the radiation curable monomer present in such radiation-curable compositions comprises an alkyl (meth)acrylate, such as methyl(meth)acrylate, ethyl(meth)acrylate, isopropyl(meth)acrylate, n-butyl(meth)acrylate, isobutyl(meth)acrylate, 2-ethylhexyl(meth)acrylate, and/or 2-hydroxyethyl(meth)acrylate. In certain embodiments, it is desired that such an alkyl (meth)acrylate comprises a long chain alkyl group containing alkyl (meth)acrylate containing from 5 to 18 carbon atoms in the alkyl portion, such as pentyl (meth)acrylate, hexyl (meth)acrylate, heptyl (meth)acrylate, 2-ethylhexyl (meth)acrylate, lauryl (meth)acrylate, stearyl (meth)acrylate, isodecyl (meth)acrylate, and/or isobornyl (meth)acrylate, among others.

In certain embodiments, the radiation curable monomer present in such radiation curable compositions comprises a heterocyclic vinyl compound, such as, for example, N-vinyl-2-pyrrolidone, N-vinyl-2-piperidone, N-vinyl-ε-caprolactam, N-vinyl-5-methyl-2-pyrrolidone, N-vinyl-3,3,5-trimethyl-2-pyrrolidone, N-vinyl-3-methyl-2-pyrrolidone, isomers, derivatives and mixtures thereof.

In certain embodiments, the radiation curable monomer present in such radiation curable compositions comprises a vinyl ether, such as vinyl methyl ether, vinyl ethyl ether, vinyl n-butyl ether, vinyl 2-chloroethyl ether, vinyl isobutyl ether, vinyl phenyl ether and vinyl 2-ethylhexyl ether, vinyl ethers of substituted aliphatic alcohols, such as 1,4-di(ethenoxy)butane, vinyl 4-hydroxy-butyl ether, diethylene glycol divinyl ether, triethylene glycol divinyl ether, bis(4-(vinyloxy)butyl) isophthalate, bis[[4-[(vinyloxy)methyl]cyclohexyl]methyl]terephthalate, bis(4-(vinyloxy)butyl)adipate, bis[4-(vinyloxy)butyl] 1,6-hexanediylbiscarbamate, tris(4-(vinyloxy)butyl)trimellitate, cyclic formals, such as trioxane, 1,3-dioxolane, 2-vinyl-1,3-dioxolane, and 2-methyl-1,3-dioxolane, and cyclic siloxanes that can contain various groups attached to the silicon atom, such as a hydrocarbon radical (alkyl, aryl, alkaryl), an alkenyl hydrocarbon radical (vinyl, allyl or acryloyloxy-alkyl), a halogenated hydrocarbon radical, a carboxy-containing hydrocarbon radical or ester group, a cyanohydrocarbon radical, hydrogen, halogen or a hydroxy group.

In certain embodiments, the radiation-curable monomer present in such radiation-curable compositions comprises a combination of a long chain alkyl group containing alkyl (meth)acrylate containing from 5 to 18 carbon atoms in the alkyl portion, such as lauryl (meth)acrylate, a heterocyclic vinyl compound, such as N-vinyl-2-pyrrolidone, and a vinyl ether, such as diethylene glycol divinyl ether.

In certain embodiments, the radiation-curable monomer is present in such radiation curable compositions in an amount of 10 to 90 percent by weight, such as 30 to 60 percent by weight, with the weight percents being based on the total weight of the composition.

In certain embodiments, the radiation-curable compositions utilized in the practice of the methods of the present invention are substantially free or, in some cases, completely free of multi-functional (meth)acrylate monomers. As used herein, the term “multi-functional (meth)acrylate monomer” refers to monomers comprising three or more (meth)acrylate groups. Non-limiting examples of multi-functional (meth)acrylate monomers that are, in certain embodiments, substantially or completely absent from such radiation-curable compositions are glycerol tri(meth)acrylate, glycerol propoxytri(meth)acrylate, 1,2,4-butanetriol tri(meth)acrylate, pentaerythritol tetra(meth)acrylate, trimethylolpropane tri(meth)acrylate, and di-trimethylolpropane tetra(meth)acrylate. Moreover, in certain embodiments, the radiation-curable compositions utilized in the practice of the methods of the present invention are substantially free or, in some cases, completely free of any (meth)acrylated amine synergist, such as the product commercially available from Rahn Corp. as GENOMER 5275, which are often used in such compositions, and which, in many cases, can cause yellowing and compatibility problems.

As used herein, the term “substantially free” mean that the material being discussed is present in a composition, if at all, in an amount such that the presence of the material does not affect the properties of the composition, which, in the present invention, means that the material being discussed is not present in the radiation-curable composition in an amount sufficient to prevent its use in the methods of the present invention. As used herein, the term “completely free” means that the material being discussed is not present in a composition at all.

In certain embodiments, particularly when the radiation-curable compositions utilized in the practice of the methods of the present invention are to be cured by exposure to ultraviolet radiation, such compositions comprise from 0.1 to 5.0 percent by weight, based on solids, of a photopolymerization initiator, i.e., a photoinitiator. Examples of suitable photoinitiators include isobutyl benzoin ether, mixtures of butyl isomers of butyl benzoin ether, α,α-diethoxyacetophenone, and α,α-dimethoxy-α-phenylacetophenone. Other examples of photoinitiators and photosensitizers can be found in U.S. Pat. No. 4,017,652, incorporated by reference herein.

In certain embodiments, such radiation-curable compositions also comprise a photopolymerization sensitizer, i.e., a photosensitizer. Examples of photosensitizers include benzophenone, anthraquinone, thioxanthone and phosphine oxides. In certain embodiments, such compositions comprise less than 1 percent by weight, such as 0.5 percent by weight, based on solids, of a photosensitizer. UV stabilizers can also be added including benzotriazoles, hydrophenyl triazines and hindered amine light stabilizers, for example those commercially available from Ciba Specialty Chemicals in their TINUVIN line.

In certain embodiments, the radiation-curable coating compositions utilized in the practice of the methods of the present invention also comprise any of a variety of other additives, such as rheology modifiers, surfactants, UV-light stabilizer, dyes, pigments, sanding additives, antioxidants, solvents, and flatting agents (e.g. wax-coated or non-wax coated silica or other inorganic materials), among other materials.

The methods of the present invention also comprise the step of subjecting the at least partially coated substrate to ionizing radiation or actinic radiation in an inert atmosphere to cure the radiation-curable composition. As used herein, the term “ionizing irradiation”, refers to high energy radiation and/or the secondary energies resulting from conversion of electrons or other particle energy to X-rays or gamma radiation. While various types of irradiation are suitable for this purpose, such as X-ray and gamma rays, the radiation produced by accelerated high energy electrons can sometimes be particularly suitable. However, regardless of the type of radiation and the type of equipment used for its generation or application, the use thereof in the practice of the invention as described herein is contemplated as falling within the scope of this invention so long as the ionization radiation is equivalent to at least 100,000 electron volts.

While there is no upper limit to the electron energy that can be so applied advantageously, it is believed that the effects desired in the practice of this invention can be accomplished without having to go to above 20,000,000 electron volts. Generally, the higher the electron energy used, the greater is the depth of penetration into the massive structure of the materials to be treated. For other types of radiation, such as gamma and X-rays, energy systems equivalent to the above range of electron volts are often desirable.

As used herein, the term “irradiation” includes what has been referred to in the prior art as “ionizing radiation” which has been defined as radiation possessing an energy at least sufficient to produce ions or to break chemical bonds and thus includes also radiations such as “ionizing particle radiation” as well as radiations of the type termed “ionizing electromagnetic radiation”. The term “ionizing particle radiation” has been used to designate the emission of electrons or highly accelerated nuclear particles such as protons, neutrons, alpha-particles, deuterons, beta-particles, or their analogs, directed in such a way that the particle is projected into the mass to be irradiated. Charged particles can be accelerated by the aid of voltage gradients by such devices as accelerators with resonance chambers, Van der Graaff generators, betatrons, synchrotons, cyclotrons, etc. Neutron radiation can be produced by bombarding a selected light metal, such as beryllium, with positive particles of high energy. Particle radiation can also be obtained by the use of an atomic pile, radioactive isotopes or other natural or synthetic radioactive materials.

“Ionizing electromagnetic irradiation” is produced when a metallic target, such as tungsten, is bombarded with electrons of suitable energy. This energy is conferred to the electrons by potential accelerators of over 0.1 million electron volts. In addition to irradiation of this type, commonly called X-ray, an ionizing electromagnetic irradiation suitable for the practice of this invention can be obtained by means of a nuclear reactor (pile) or by the use of natural or synthetic radioactive material, for example, cobalt 60.

Various types of high power electron linear accelerators are commercially available and are described in, for example, U.S. Pat. No. 2,763,609 and in British Pat. No. 762,953.

The amount of ionizing irradiation employed can range, for example, from 0.2 megarad to 20 megarads, such as between 0.2 megarad and 10 megarads, at, for example, 150 to 300 kiloelectron volts, such as 170 to 250 kiloelectron volts. A “rad” is defined as that amount of radiation required to supply 100 ergs per gram of material being treated, and a “megarad” is 10⁶ rads. The total dosage is the total amount of irradiation received by the material.

As used herein, the term “actinic radiation” refers to actinic light, such as ultraviolet light. Any suitable source which emits ultraviolet light having a wavelength of 180 to 400 nanometers may be used in the practice of the present invention. Suitable sources are mercury vapor lamps, carbon arcs, low pressure mercury vapor lamps, medium pressure mercury vapor lamps, high pressure mercury vapor lamps, swirl-flow plasma arcs, ultraviolet light emitting diodes and ultraviolet light emitting lasers.

The time of exposure to ultraviolet light and the intensity of the ultraviolet light to which the coating composition is exposed may vary greatly. Generally, the exposure to ultraviolet light should continue until either the film is thermoset throughout or at least cured to the point where subsequent reactions cause the film to thermoset throughout. The appropriate time of exposure and intensity of ultraviolet light used can be determined by those skilled in the art.

As indicated, in the methods of the present invention, the at least partially coated substrate is subjected to ionizing radiation or actinic radiation in an inert atmosphere. As used herein, the term “inert atmosphere” refers to an atmosphere either containing less than 5,000, in some cases, no more than 4,000, or, in yet other cases, 400 to 4,000 parts per million of oxygen. In some cases, the inert atmosphere contains no more than 1,000, such as 300 to 1,000, parts per million of oxygen. Gases such as nitrogen, argon, carbon dioxide, or mixtures thereof are often the major components of the inert atmosphere, although other non-reactive gases may be used. In certain embodiments, nitrogen is employed for this purpose.

As previously indicated, the methods of the present invention do not include the step of at least partially curing the radiation-curable composition by subjecting the at least partially coated substrate to ionizing radiation or actinic radiation in an atmosphere containing a low gloss imparting amount of oxygen. In other words, the methods of the present invention do not include an “air cure” step. As used herein, the phrase “low gloss imparting amount of oxygen” refers to an atmosphere of at least 5,000 parts per million of oxygen.

The inventors have surprisingly discovered that it is possible to produce coatings that are non-glossy, as well as stain resistant and/or scratch resistant, when practicing the methods of the present invention. Previously, it had been thought that a technique including an “air cure” step, such as the “dual cure” technique described in, for example, U.S. Pat. No. 3,918,393, was required in order to produce strong, reduced-gloss coatings, from radiation curable compositions. The need for reduced gloss coatings having excellent properties is found in many applications, such as interior flooring applications.

As used herein, the term “non-glossy” refers to cured coatings that have a dry film thickness of up to 100 microns and a 60° gloss, measured as described below, of no more than 70, in some cases from 50 to 65, and, in yet other cases, from 50 to 60, gloss units. As used herein, the term “gloss” refers to the ability of a coating to reflect light, with a higher gloss value corresponding to a larger amount of light being reflected. As will be understood by those skilled in the art, gloss measurements can be made using a BYK/Haze Gloss meter available from Gardner Instrument Company, Inc. As used herein, the term “60° gloss” refers to the gloss of a coated substrate determined at a 60° angle using such a BYK/Haze Gloss meter.

As used herein, the term “stain resistant” refers to coatings that are not significantly stained, i.e., have a stain rating of 1 or less, as described in the Examples herein, after placing red food coloring on a coated panel, covering the stain to prevent evaporation, and allowing the stain to remain in contact with the coating for 6 hours at which time the stain is removed with a damp (tap water) cloth. Such a method is based on ASTM 3023.

As used herein, the term “scratch resistant” refers to coatings that both (i) retain at least 90% of their initial gloss value after subjecting the coated substrate to 200 cycles of dry Type A abrasive Scotch Brite abrasive pad (3M) under a 2 pound load in accordance with ASTM 2486, and (ii) show no visible cut of the coating to the substrate when tested in accordance with ASTM 2197 with Hoffman attachment under 2000 gram load.

As will be appreciated based on the foregoing description, the present invention is also directed to substrates, such as wood substrates, that are at least partially coated with a non-glossy, stain resistant and scratch resistant coating produced by a method of the present invention. The present invention is also directed to coating compositions suitable for use in such methods.

Illustrating the invention are the following examples, which, however, are not to be considered as limiting the invention to their details. Unless otherwise indicated, all parts and percentages in the following examples, as well as throughout the specification, are by weight.

### EXAMPLE 1

A coating composition was prepared by charging the components and amounts listed in Table 1 to a suitable vessel under agitation.

TABLE 1

| Component | Amount (weight percent) |
|---|---|
| Specialty Resin 01-554¹ | 27.5 |
| Modaflow ®² | 0.04 |
| Aliphatic urethane acrylate resin³ | 48.17 |
| N-vinyl pyrrolidone⁴ | 11 |
| OK-412 silica⁵ | 7.65 |
| WCA-3⁶ | 3.6 |
| Benzophenone⁷ | 0.43 |
| Darocur 1173⁸ | 1.6 |

¹Believed to be a blend of triethylene glycol divinyl ether and lauryl acrylate, commercially available from Rahn Corp.
²Flow additive commercially available from Cytec Industries.
³A difunctional urethane acrylate resin having a molecular weight of about 3,000.
⁴Commercially available from BASF.
⁵Wax treated silica commercially available from Degussa.
⁶Alumina commercially available from Micro Abrasives.
⁷Photoinitiator commercially available from Innochem.
⁸Photoinitiator commercially available from CIBA.

The composition of Table 1 was applied by a roll coater to an oak panel at a film thickness of 0.4 mils. This composition was also applied at film thicknesses of 1, 3, and 4 mils using the appropriate wire wound bar onto a Form 7B Leneta chart. The composition was subjected to ionizing radiation from a medium pressure mercury vapor lamp in a nitrogen atmosphere containing oxygen, as measured by an oxygen analyzer, in the amounts set forth in Table 2. Results are set forth in Table 2.

TABLE 2

| | Film | | Initial | | |
|---|---|---|---|---|---|
| Example | Thickness | Atmosphere | Gloss⁹ | Stain Resistance¹⁰ | Scratch Resistance¹¹ |
| 1A | 0.4 mils | 3,000 ppm oxygen | 57 | Iodine - 3 | Final Gloss - 64 |
| | | | | Black Rit Dye - 3 | % Gloss Retention - |
| | | | | Red Food Coloring - 0.5 | 112 |
| | | | | Mustard - 1 | Hoffman - pass |
| | | | | Brown Shoe Polish - 0 | |
| 1B | 1 mil | 300 ppm oxygen | 66 | n/a | n/a |
| 1C | 3 mils | 300 ppm oxygen | 66 | n/a | n/a |
| 1D | 4 mils | 300 ppm oxygen | 68 | n/a | n/a |

⁹60° gloss value measured using a BYK/Haze Gloss meter available from Gardner Instrument Company, Inc.
¹⁰Stain resistance is measured as described above and reported on a scale of 0 to 5, wherein 0 represents no visible stain and 5 represents severe/permanent staining.
¹¹Final gloss reading is a 60° gloss value measured as described above after subjecting the coated substrate to 200 cycles of dry Type A abrasive Scotch Brite abrasive pad (3 M) under a 2 pound load in accordance with ASTM 2486. % Gloss Retention is the initial gloss divided by the final gloss. Hoffman “pass” means that no visible cut of the coating to the substrate was observed when tested in accordance with ASTM 2197 with Hoffman attachment under 2000 grams load.

### EXAMPLE 2

DURASTEP 60 gloss flooring topcoat, an aliphatic urethane acrylate based hardwood flooring topcoat, commercially available from PPG Industries, Inc., was applied by a roll coater to an oak panel at a film thickness of 0.5 mils. In Example 2A, the composition was subjected to ionizing radiation from a medium pressure mercury vapor lamp in an ambient air atmosphere. In Example 2B, the composition was subjected to ionizing radiation from a medium pressure mercury vapor lamp in a nitrogen atmosphere containing about 3000 parts per million of oxygen as measured by an oxygen analyzer. Results are set forth in Table 3.

TABLE 3

| | Initial | | |
|---|---|---|---|
| Example | Gloss | Stain Resistance | Scratch Resistance |
| 2A | 57 | Iodine - 4 | Final Gloss - 62 |
| | | Black Rit Dye - 3 | % Gloss Retention - 108 |
| | | Red Food Coloring - 1 | Hoffman - pass |
| | | Mustard - 1 | |
| | | Brown Shoe Polish - 0 | |
| 2B | 71 | Iodine - 5 | Final Gloss - 73 |
| | | Black Rit Dye - 1 | % Gloss Retention - 104 |
| | | Red Food Coloring - 0.5 | Hoffman - n/a |
| | | Mustard - 1 | |
| | | Brown Shoe Polish - 0 | |

### EXAMPLE 3

A DURASTEP 60 gloss flooring topcoat composition was modified by increasing the amount of flatting pigment (OK-412 silica) from 6.7 weight percent to 8.0 weight percent.

This composition was applied by a roll coater to an oak panel at a film thickness of 0.5 mils. The composition was then subjected to ionizing radiation from a medium pressure mercury vapor lamp in a nitrogen atmosphere containing about 3000 parts per million of oxygen as measured by an oxygen analyzer. Results are set forth in Table 4.

TABLE 4

| | | | |
|---|---|---|---|
| | Initial | | |
| Example | Gloss | Stain Resistance | Scratch Resistance |

| | | | |
|---|---|---|---|
| 3 | 71 | Iodine - 5 | Final Gloss - 70 |
| | | Black Rit Dye - 1 | % Gloss Retention - 99 |
| | | Red Food Coloring - 0 | Hoffman - n/a |
| | | Mustard - 1 | |
| | | Brown Shoe Polish - 0 | |

Whereas particular embodiments of this invention have been described above for purposes of illustration, it will be evident to those skilled in the art that numerous variations of the details of the present invention may be made without departing from the invention as defined in the appended claims.

We claim:

1. A method for producing a coating on a substrate comprising:
(a) depositing a radiation-curable coating composition to at least a portion of the substrate to form an at least partially coated substrate, and
(b) subjecting the at least partially coated substrate to ionizing radiation or actinic radiation in an inert atmosphere to cure the radiation-curable composition and produce a cured coating,
wherein the cured coating is non-glossy and
wherein the method does not include the step of at least partially curing the radiation-curable composition by subjecting the at least partially coated substrate to ionizing radiation or actinic radiation in an atmosphere containing a low gloss imparting amount of oxygen.

2. The method of claim 1, wherein the coating is scratch resistant.

3. The method of claim 2, wherein the coating is stain resistant.

4. The method of claim 1, wherein the substrate is an organic substrate.

5. The method of claim 4, wherein the organic substrate is wood, wood veneer, fiberboard, particle board, composition board, paper, or cardboard.

6. The method of claim 1, wherein the radiation-curable composition comprises a radiation-curable polymer comprising a urethane acrylate.

7. The method of claim 1, wherein the radiation-curable composition comprises a radiation-curable monomer comprising a heterocyclic vinyl compound.

8. The method of claim 7, wherein the heterocyclic vinyl compound comprises N-vinyl-2-pyrrolidone.

9. The method of claim 1, wherein the radiation-curable composition comprises a radiation curable monomer comprising a long chain alkyl group containing alkyl (meth)acrylate containing from 5 to 18 carbon atoms in the alkyl portion.

10. The method of claim 1, wherein the radiation-curable composition comprises a radiation curable monomer comprising a vinyl ether.

11. The method of claim 1, wherein the radiation-curable composition comprises a heterocyclic vinyl compound, a long chain alkyl group containing alkyl (meth)acrylate containing from 5 to 18 carbon atoms in the alkyl portion, and a vinyl ether.

12. The method of claim 1, wherein the radiation-curable composition is substantially free multi-functional (meth)acrylate monomers.

13. The method of claim 1, wherein the at least partially coated substrate is subjected to ultraviolet light having a wavelength of 180 to 400 nanometers.

14. The method of claim 1, wherein the inert atmosphere contains no more than 4,000 parts per million oxygen.

15. The method of claim 14, wherein the inert atmosphere contains no more than 1,000 parts per million of oxygen.

16. The method of claim 1, wherein the major component of the inert atmosphere is nitrogen.

17. The method of claim 1, wherein the cured coating has a dry film thickness of up to 100 microns and a 60° gloss of 50 to 60 gloss units.

18. An at least partially coated substrate produced by a method comprising:
(a) depositing a radiation-curable coating composition to at least a portion of the substrate to form an at least partially coated substrate, and
(b) subjecting the at least partially coated substrate to ionizing radiation or actinic radiation in an inert atmosphere to cure the radiation-curable composition and produce a cured coating,
wherein the cured coating is non-glossy and
wherein the method does not include the step of at least partially curing the radiation-curable composition by subjecting the at least partially coated substrate to ionizing radiation or actinic radiation in an atmosphere containing a low gloss imparting amount of oxygen.
